(19) United States
(12) Patent Application Publication
(10) Pub. No.: US 2008/0296030 A1
(43) Pub. Date: Dec. 4, 2008

(54) LANDSCAPING MULCH TURNER

(76) Inventor: Tony M. Guard, Union, KY (US)

Correspondence Address: HAVERSTOCK, GARRETT & ROBERTS LLP, 611 OLIVE STREET, SUITE 1610, ST. LOUIS, MO, 63101, US

(21) Appl. No.: 12/133,137

(22) Filed: Jun. 4, 2008

Related U.S. Application Data
(60) Provisional application No. 60/932,917, filed on Jun. 4, 2007.

(51) Int. Cl. A01B 1/24; A01B 1/00

(52) U.S. Cl. 172/21; 172/378

(57) ABSTRACT

The turner for turning over and thickening a settled layer of an aggregate landscaping mulch material lying on a surface, includes a handle and a rolling head carried on the handle for rotation about an axis. The rolling head includes axially spaced endcaps supported about the axis, and elongate strips extending between the endcaps at radially spaced locations around the axis. The strips are oriented so as to have at least generally flat opposite surfaces extending in directions of the rotation, and including elongate, generally radially outwardly extending projections or lifters disposed at axially spaced locations therealong, such that the handle can be held to push or pull and roll the rolling head across a region of the layer of the landscaping mulch material such that the projections or lifters will penetrate into the mulch material and lift and reorient portions thereof to thicken the layer, without substantially disturbing the underlying surface, and the strips define cavities therebetween for receiving the mulch material, for improving the movement of the rolling head over the mulch material.

This application claims the benefit of U.S. Provisional Application No. 60/932,917, filed Jun. 4, 2007.

### TECHNICAL FIELD

This invention relates generally to apparatus for turning over landscaping top dressing materials such as mulches applied over soil for decorative appearance, moisture retention, and plant nourishment purposes, and more particularly, to a hand held rotary turner for turning over a mulch layer and thickening the layer for aerating and improving hydration and the appearance thereof, without significantly disturbing the underlying soil or other surface.

### BACKGROUND ART

The disclosure of U.S. Provisional Application No. 60/932,917, filed Jun. 4, 2007, is hereby incorporated herein in its entirety by reference.

Top dressings, such as, but not limited to, aggregate shredded wood mulches, wood bark mulches, leaf mulches, other organic material mulches, and man made material such as shredded vehicular tire mulches, are commonly used in landscaping beds around trees and shrubs for increasing the aesthetic appeal thereof, as well as for reducing weeds, improving hydration, aeration, and other useful purposes. Such top dressings typically have a desirable appearance when newly applied and for up to several weeks after application. However, after the passage of such time, the top dressing can begin to look dull and dirty, which is objectionable and undesirable for aesthetic purposes. Such top dressings can also naturally settle and compact so as to be less thick and as a result less permeable to water and air, which is unhealthy and undesirable for plants surrounded by the top dressing. Currently, to overcome these problems, it is known to use a conventional rake having a handle and fixed, elongate tines or fingers to “rake” mulch top dressings. However, this is typically time consuming and often produces clumps and unevenness in the top dressing, and otherwise makes the mulch look less aesthetically appealing than desired. Raking is also a fairly exerting exercise. From my U.S. Pat. No. 6,631,770, it is known to provide a turner and method specifically directed to mulch. However, the barrel or cylinder shaped rolling head of this device can be disadvantageous, as the barrel or cylinder has no capacity to accommodate the irregularity of the mulch surface, and is more costly to manufacture than desired.

Accordingly, what is sought is apparatus for more easily and effectively turning over and thickening or fluffing top dressings such as wood mulches and the like, which does not suffer from the aforementioned problems or disadvantages.

### DISCLOSURE OF THE INVENTION

In accordance with the present invention, a turner for quickly, easily, and aesthetically turning over and thickening a settled or compacted layer of an aggregate landscaping mulch material for overcoming the above discussed problems and disadvantages, is disclosed.

According to one preferred embodiment of the invention, the turner includes a handle and a rolling head carried on the handle and configured for rotation relative thereto about a rotational axis. The rolling head includes a first endcap supported about the rotational axis for rotation thereabout, a second endcap supported about the rotational axis for rotation thereabout in axially spaced relation to the first endcap, and a plurality of elongate strips, which function as mulch “flippers”, extending between the endcaps at radially spaced locations around the axis. Each of the strips or flippers preferably has oppositely facing, generally flat surfaces extending between the endcaps and oriented so as to face in opposite directions of rotation of the rolling head, adjacent ones of the strips defining cavities therebetween, respectively, preferably extending the entire distance between the endcaps. And, each of the strips or flippers additionally preferably includes a radial outer edge with a plurality of elongate projections or mulch lifters extending at least generally radially outwardly therefrom at axially spaced locations therealong. The projections preferably have a flatted profile in one direction, to facilitate the mulch lifting function.

In use, the handle is held to push or pull the rolling head across a region of the layer of the landscaping mulch material to rotate the rolling head in contact with the mulch material. The radial outer edges of the strips of flippers are capable of supporting the rolling head for movement over the layer of the mulch material while the projections or mulch lifters will penetrate into the mulch material, and lift and reorient or “flip” portions thereof to thicken the layer. As this is occurring, some of the mulch material will be received or accommodated in the cavities between the adjacent ones of the strips, so as to provide a smoother rolling action, and also for lifting and reorienting at least some of the mulch received in the cavities, to thereby increase the mulch turning capacity of the turner. In this regard, in some instances, the cavities and the surface area of the surfaces of the strips facing the cavities combine to significantly increase the mulch lifting and turning capacity of the rolling head. This rolling head configuration also facilitates manufacture, as the strips and projections or mulch lifters can be easily stamped as a unitary member from a suitable material, such as, but not limited to, a metal such as steel, and the strips are easily assembled with the endcaps. Alternatively, stiff rods or wire can be used in place of the strips, with the projections also comprised of rod or wire, which can be welded or otherwise suitably rigidly attached, and flattened if desired to improve the mulch lifting capability.

### BRIEF DESCRIPTION OF THE DRAWINGS

FIG. 1 is a perspective view of a landscaping mulch turner according to the present invention, and an associated elongate handle extension therefor;

FIG. 2 is a perspective illustration of the mulch turner of FIG. 1 being used for turning over and thickening a region of a layer of a landscaping mulch material;

FIG. 3 is a fragmentary exploded view of a rolling head of the mulch turner of FIG. 1;

FIG. 4 is another fragmentary exploded view of the mulch turner of FIG. 1, showing aspects of assembly thereof;

FIG. 5 is an end view of the mulch turner being used for turning and thickening a layer of a mulch material; and

FIG. 6 is another end view of the mulch turner being used for turning and thickening a layer of a mulch material, with a portion of an endcap of the rolling head removed, to show capacity.

### DETAILED DESCRIPTION OF THE PREFERRED EMBODIMENTS

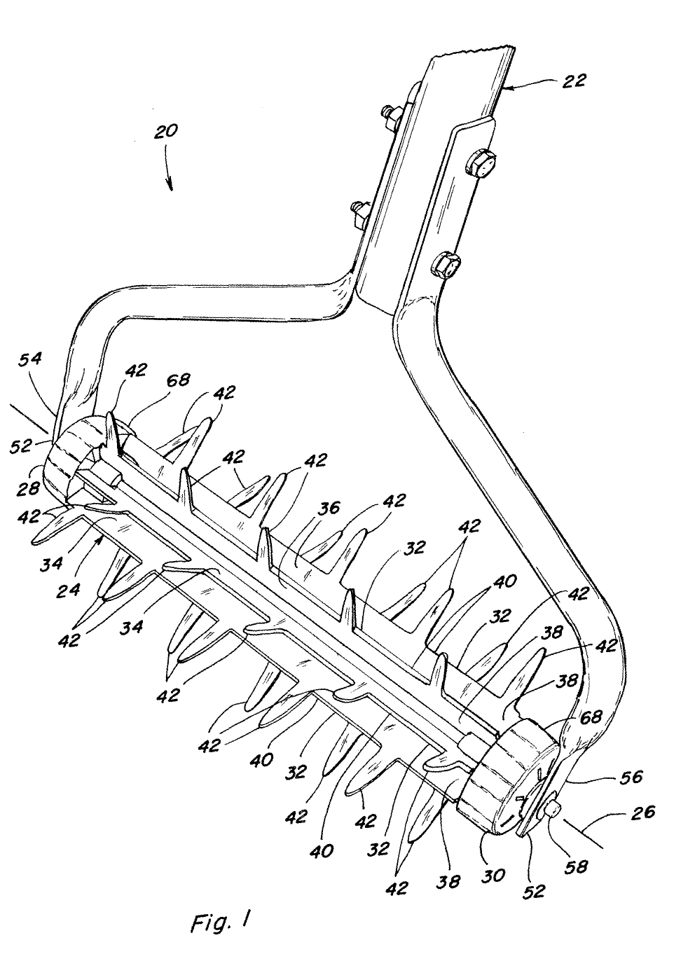

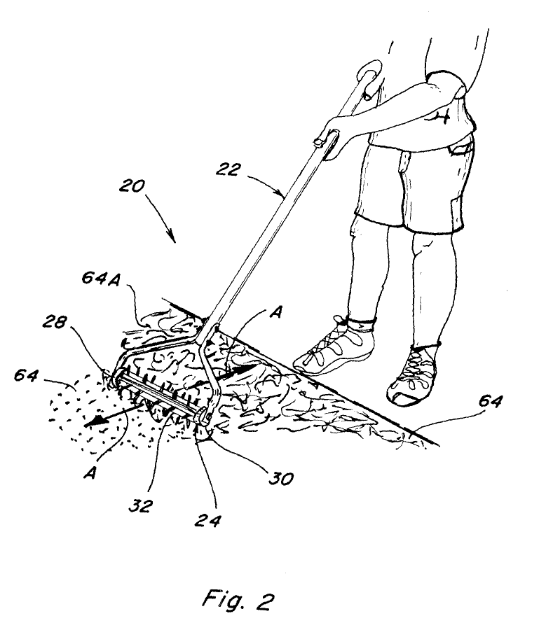

Turning now to the drawings, wherein several preferred embodiments of the present invention are shown, in FIGS. 1 and 2, a mulch turner 20 constructed and operable according to the teachings of the present invention for turning over and thickening a settled or compacted layer of an aggregate landscaping mulch material, is shown. Turner 20 includes a handle 22, and a rolling head 24 carried on handle 22 and configured for rotation relative thereto about a rotational axis 26. Rolling head 24 includes a first endcap 28 supported about rotational axis 26 for rotation thereabout, a second endcap 30 supported about rotational axis 26 for rotation thereabout in axially spaced relation to first endcap 28, and a plurality of elongate strips 32 extending between the endcaps at radially spaced locations around the axis.

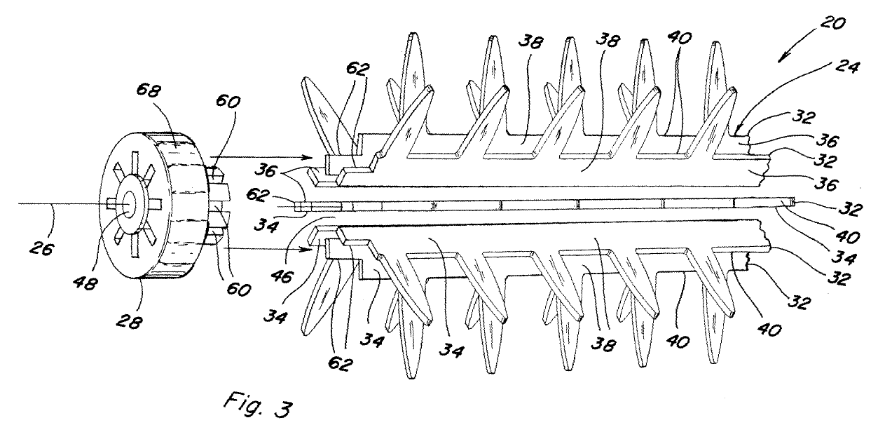

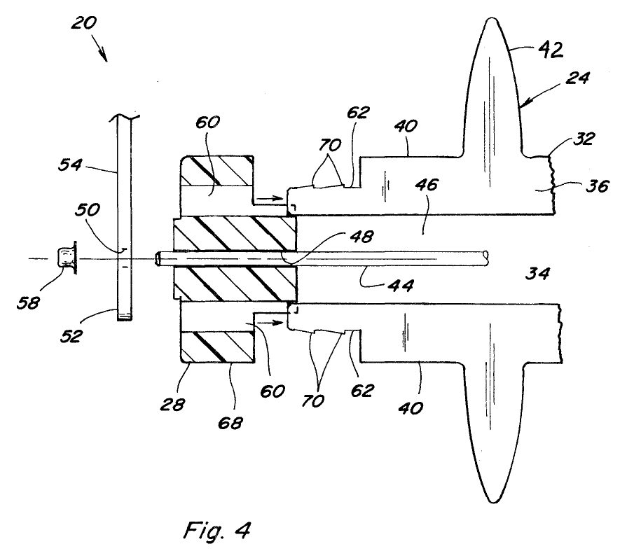

Referring also to FIGS. 3 and 4, each strip 32 includes oppositely facing, generally flat surfaces 34 and 36 extending between endcaps 28 and 30 and oriented so as to face in opposite directions of rotation of rolling head 24. Adjacent ones of strips 32 define cavities 38 therebetween, respectively, each of strips 32 including a radial outer edge 40 with a plurality of elongate mulch lifters or projections 42 extending at least generally radially outwardly therefrom at axially spaced locations therealong. Rolling head 24 additionally preferably includes a central, axially extending axle 44 (FIG. 4) which extends through a space 46 defined by the radial inner edges of strips 32, through a passage 48 through each endcap 28 and 30, and through holes 50 through respective distal ends 52 of arms 54 and 56 of handle 22, for rotatably connecting rolling head 24 to handle 22. Axle 44 is captured at each end between arms 54 and 56, by a frictional press nut 58 or other suitable fastener, outside of the respective distal ends 52. Alternatively, other axle arrangements, such as stub axles (not shown) integrally formed with endcaps 28 and 30, could be used.

Each strip 32, and projections 42 thereof, are preferably suitably rigid for use in the intended manner, and integrally formed, such as by die stamping from a metal such as steel, aluminum or the like, although it should be understood that it is contemplated that other constructions can be used for strips 32, including, but not limited to, injection molding from a plastics material.

Each endcap 28 and 30 is preferably generally disc shaped, including passage 48 extending therethrough. Each endcap 28 and 30 additionally includes a plurality of slots 60 configured so as to extend radially outwardly from axis 26, in an angularly spaced array therearound. Each slot 60 is sized and shaped for cooperatively receiving a tab 62 extending longitudinally from the end of one of the strips 32, and retaining the tab 62 for holding the endcap 28 or 30 together with strips 32 engaged therewith. This can be accomplished with a friction fit of tab 62 within slot 60, and/or use of a suitable mechanical detent, such as barbs 70 illustrated, or a suitable fastener or adhesive. This assembly will also be retained together by the positioning of rolling head 24 between distal ends 52 of arms 54 and 56. Endcaps 28 and 30 can be of any suitable construction, such as, but not limited to, injection molded plastics, metal such as a die cast steel or aluminum, or the like.

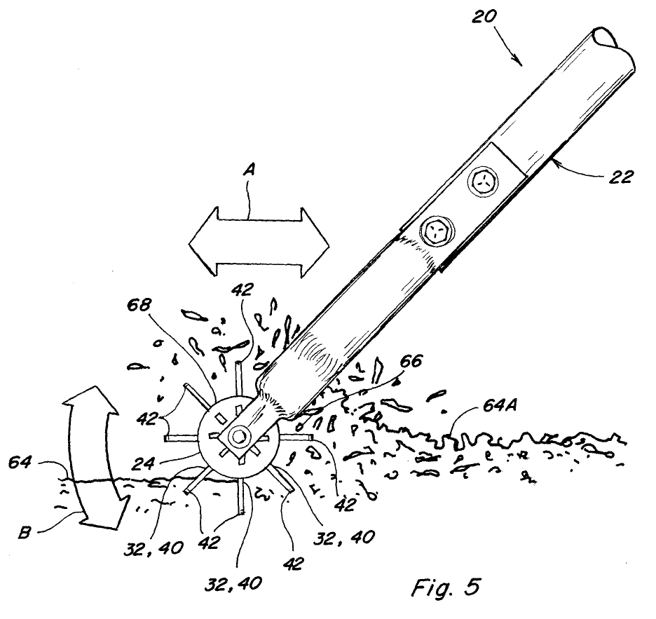

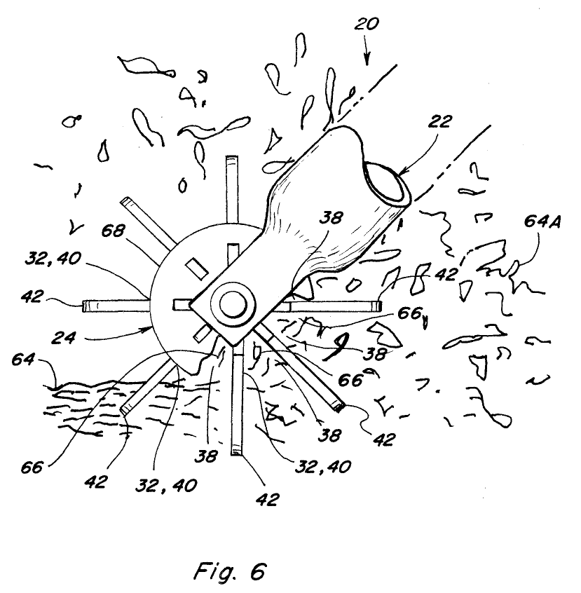

As illustrated in FIGS. 2, 5 and 6, in use, handle 22 can be held to push or pull rolling head 24 across a region of a layer 64 of landscaping mulch material, as denoted by arrows A in FIGS. 2 and 5, to rotate rolling head 24, as denoted by arrow B in FIG. 5, such that radial outer edges 40 of strips 32 will support rolling head 24 on layer 64 while projections 42 will penetrate into the mulch material and lift and reorient portions thereof to thicken the layer, as denoted by number 64A. During this movement, some of the mulch material, generally denoted by number 66 in FIGS. 5 and 6, will be received in cavities 38 between the adjacent ones of strips 32. Also during this action, as noted above, strips 32 and projections 42 will preferably function together as “flippers” to lift and reorient or “flip” the mulch material as denoted by number 66 in FIGS. 5 and 6. Surfaces 34 and 36 (best shown in FIG. 1) of strips 32 will facilitate and contribute to this flipping action. As an additional feature, endcaps 28 and 30 will preferably have a radial outer surface 68, which is of sufficient extent, particularly, axially, so as to also provide some support for rolling head 24 during the mulch turning, to provide a depth control function, to prevent or limit sinking and/or or plowing of the rolling head through the mulch.

Here, it can be envisioned that, as a result of working using turner 20, the individual pieces of the mulch material are now related to one another so as to form relatively large spaces or voids therebetween thereby aerating and thickening the mulch layer. Mulch material 64 is representative of a wide variety of aggregate mulch materials, including, but not limited to, shredded wood mulches, wood bark mulches, leaf mulches, other organic material mulches, and man-made material such as shredded vehicular tire mulches, commonly used in landscaping beds around trees and shrubs for increasing the aesthetic appeal thereof, and for reducing weeds, improving hydration, aeration, and other useful purposes.

For optimal ease of movement over and turnover and thickening or fluffing of a mulch layer, it has been found that the rolling head, such as rolling head 24 illustrated, preferably will have a diametrical extent of no more than about 5 inches, and preferably about 1 to about 3 inches, and projections 42 will preferably have an average length of from about 0.7 inch to about 2.5 inches, larger lengths being best adapted for use with a larger diameter barrel 22, the preferred projection length for use with the preferred 1 to 3 inch diameter rolling head being from about 1 to about 1.5 inches. As one preferred embodiment, rolling head 24 will include at least 4, and preferably 6, and more preferably 8 strips 32, as required for providing the desired mulch turning capability. In this regard, the radial outer edges 40 of the strips will form essentially a hollow “virtual” cylinder on which the rolling head will roll. It should be noted that it has been found that by using a rolling head 24 having the preferred diametrical extent, with 8 strips 32 at equally spaced locations around the head, and projections 42 of the preferred length, rolling head 24 will roll satisfactorily over the mulch surface, and as projections 42 emerge from a mulch layer as rolling head 24 is rotated thereover, projections 42 will be sufficiently near to a horizontal orientation so as to effectively be capable of lifting individual pieces of the mulch material from the surface thereof sufficiently such that the pieces will roll off of projections 42 and turn or flip over so as to be dropped back onto the mulch layer in a different orientation from their original orientation and spaced farther apart, thereby aerating and thickening or fluffing the mulch layer. The flat sectional extent of projections 42 will also facilitate insertion in essentially a knifing action into the mulch material. Due also to the light weight of turner 20, and the length of projections 42 within the specified range, the more compacted soil or other surface underlying the mulch layer will not be significantly disturbed, that is, the soil or other underlying material will not be penetrated and brought to the top surface of the mulch layer by the projections, which is a desirable effect as weeds can grow in unintentionally exposed soil.

It has been found that using a lightweight mulch turner, having components such as rolling head 24, strips 32 including projections 42, and handle 20, made from a lightweight rigid material, such as a plastics material or aluminum, enables rolling head 24 to be easily pushed and pulled to traverse over a top surface of a mulch layer, without significantly plowing or burrowing therein, but such that projections 42 can penetrate into the aggregate mulch material and when withdrawn therefrom by the rotation, lift and re-orient or flip or turn over individual pieces of the aggregate mulch material, to thereby aerate and thicken or fluff the mulch material, and improve its aesthetic look and air and water permeability. In this regard, it has been observed that typical aggregate landscaping mulches have a tendency to settle and compact over time such that a layer or the mulch material can decrease in thickness, for instance, from an original thickness of 4 to 6 inches, to a thickness of 2 inches or less, which drastically decreases the aesthetic appeal thereof, and the greater density of which reduces the ability of air and moisture to pass through the mulch from the top surface thereof, as is desired for proper aeration and hydration of plant roots contained in the underlying soil. Here, rolling head 24 is illustrated supported by a handle having two arms 54 and 56 on either side. However, it should be noted that a cantilever arrangement could also be used, as illustrated in my prior U.S. Pat. No. 6,631,770, as would be advantageous to allow easy passage under low canopies and foliage of small shrubs, bushes, flowers, and other plants. The cantilever arrangement also allows easy manipulation over mulch closely around plant stems and trunks and other obstacles. Using the preferred components discussed above, as well as those discussed hereinafter, turner 20 will have an overall weight of less than about 10 pounds, and more preferably 6 to 8 pounds or less, which has been found to provide easy maneuverability and movement with minimal exertion, and also allows the turner to remain on top of the mulch layer, to provide the advantages discussed above.

It should be noted that it is contemplated that rolling head 24 could be manufactured in other ways. For instance, rods or wires could be used in place of or as strips 32, to form a rod or wire frame virtual cylinder shape, and projections 42 could be similarly of rod or wire, welded or otherwise suitably rigidly attached to the rods or wires so as to extend radially outwardly therefrom. The rod or wire projections can also be flattened, or otherwise suitably shaped, to facilitate the mulch knifing and lifting functions discussed above.

As another feature of the invention, due to the rigidity of the structure of rolling head 24, turner 20 has utility for performing light soil aeration, or roughening, for instance, for preparing the soil for planting of seeds and the like.

Thus, there has been shown and described a novel invention in a light weight, easy to use rotatable mulch turner which overcomes many of the problems set forth above. It will be apparent, however, to those familiar in the art, that many changes, variations, modifications, and other uses and applications for the subject device are possible. All such changes, variations, modifications, and other uses and applications that do not depart from the spirit and scope of the invention are deemed to be covered by the invention which is limited only by the claims which follow.

What is claimed is:

1. A turner for turning over and thickening a settled layer of an aggregate landscaping mulch material lying on a surface, comprising:
a handle; and
a rolling head carried on the handle and configured for rotation relative thereto about a rotational axis, the rolling head including a first endcap supported about the rotational axis for rotation thereabout, a second endcap supported about the rotational axis for rotation thereabout in axially spaced relation to the first endcap, and a plurality of elongate strips extending between the endcaps at radially spaced locations around the axis, each of the strips having oppositely facing, generally flat surfaces extending between the endcaps and oriented so as to face in opposite directions of rotation of the rolling head, adjacent ones of the strips defining cavities therebetween, respectively, each of the strips including a radial outer edge with a plurality of elongate projections extending at least generally radially outwardly therefrom at axially spaced locations therealong;
wherein the handle can be held to push or pull the rolling head across a region of the layer of the landscaping mulch material to rotate the rolling head such that the radial outer edges of the strips will support the rolling head on the layer of the mulch material while the projections will penetrate into the mulch material and lift and reorient portions thereof to thicken the layer, and some of the mulch material will be received in the cavities between the adjacent ones of the strips.

2. The turner of claim 1, wherein the projections have an average length of from about 0.7 inch to about 2.5 inches.

3. The turner of claim 1, wherein each of the strips comprises a unitary member.

4. The turner of claim 3 wherein the strips are disposed in a circular array about the rotational axis, and circumscribe a radial outer diametrical extent of between about 1 inch and about 3 inches.

5. The turner of claim 3, wherein the projections of adjacent ones of the strips are axially offset one relative to another.

6. The turner of claim 1, comprising about 8 of the strips disposed in an evenly angularly spaced array about the rotational axis.

7. The turner of claim 1, comprising at least about 6 of the strips disposed at evenly angularly spaced locations about the rotational axis.

8. The turner of claim 1, wherein each of the strips includes longitudinally opposite end portions having tabs cooperatively received and retained in slots in the endcaps, respectively.

9. The turner of claim 1, wherein each of the endcaps includes a radial outer circumferential surface extending therearound configured for supporting the rolling head on the mulch material.

10. The turner of claim 1, wherein the handle includes at least one arm connected to the rolling head.

11. The turner of claim 1, wherein the rolling head is connected to the handle by an axle extending axially through the rolling head, and the cavities between the adjacent ones of the strips extend radially inwardly to a location adjacent to the axle.

12. A turner for turning over and thickening a settled layer of an aggregate landscaping mulch material lying on a surface, comprising:
a handle; and
a rolling head carried on the handle and configured for rotation relative thereto about a rotational axis, the rolling head including a first endcap supported about the rotational axis for rotation thereabout, a second endcap supported about the rotational axis for rotation thereabout in axially spaced relation to the first endcap, and a plurality of elongate, generally radially extending, generally flat strips extending between the endcaps at radially spaced locations around the axis, each of the strips being configured and oriented so as to have a radial outer edge including a plurality of elongate mulch lifters extending radially outwardly therefrom at axially spaced locations therealong, each of the strips including oppositely longitudinally extending tabs retained in slots in the endcaps, respectively, and adjacent ones of the strips defining cavities therebetween extending between the endcaps;
wherein the handle can be held to push or pull the rolling head across a region of the layer of the landscaping mulch material to rotate the rolling head supported on the mulch material on the radial outer edges of the strips, and such that the mulch lifters will penetrate into the mulch material and lift and reorient portions thereof to thicken the layer.

13. The turner of claim 12, wherein the mulch lifters have an average length of from about 0.7 inch to about 2.5 inches.

14. The turner of claim 12 wherein the radial outer edges of the strips are arranged in an circular array about the rotational axis, the array having a radial outer diametrical extent of between about 1 inch and about 3 inches.

15. The turner of claim 12, wherein the handle has an elongate portion of sufficient length to enable a person to hold a distal end of the handle for pushing or pulling the rolling head over the region of the layer of the mulch material.

16. The turner of claim 12, wherein the mulch lifters of adjacent ones of the strips are axially offset one relative to another.

18. The turner of claim 12, wherein each of the strips and the mulch lifters thereof are of unitary construction of stamped sheet metal.

19. Apparatus for turning over and thickening a layer of an aggregate mulch material on an underlying surface of a compacted material, comprising:
a handle; and
a rolling head carried on the handle and configured for rotation relative thereto about a rotational axis, the rolling head including a first endcap supported about the rotational axis for rotation thereabout, a second endcap supported about the rotational axis for rotation thereabout in axially spaced relation to the first endcap, and a plurality of elongate, generally radially extending, generally flat strips extending between the endcaps at radially spaced locations around the axis, each of the strips being configured and oriented so as to have a radial outer edge including a plurality of elongate mulch lifters extending radially outwardly therefrom at axially spaced locations therealong, each of the strips including oppositely longitudinally extending tabs retained in slots in the endcaps, respectively, and adjacent ones of the strips defining cavities therebetween extending between the endcaps, such that radial outer edges of the strips form a generally cylindrical shape body extending between the endcaps, with the cavities disposed between the mulch lifters of the strips, respectively;
the handle being capable of being held to move the rolling head over a region of the layer of the mulch material having portions in a first orientation and the rolling head having a sufficiently small diametrical extent and the mulch lifters being sufficiently long such that the lifters will penetrate the portions of the mulch material and lift and turn the portions over and deposit the portions back on the layer of the mulch material in a second orientation different from the first orientation and so as to increase the vertical extent of the region of the layer so as to have larger spaces and voids between individual portions of the mulch material compared to prior to when the portions of the mulch material were lifted and turned by the lifters for aerating the mulch material without significantly disturbing the underlying surface of the compacted material, and such that the mulch material can enter the cavities between the strips as the rolling head is moved thereover.
